(19) United States
(12) Patent Application Publication
(10) Pub. No.: US 2011/0061677 A1
(43) Pub. Date: Mar. 17, 2011

(54) PRODUCTION METHOD OF HOT-ROLLED STEEL SHEET

(76) Inventors: Katsuyuki Yanagihara, Tokyo (JP); Yasumitsu Kondo, Tokyo (JP)

(21) Appl. No.: 12/736,827

(22) PCT Filed: May 13, 2009
(86) PCT No.: PCT/JP2009/059237

§ 371 Date: Nov. 9, 2010

(30) Foreign Application Priority Data
May 13, 2008 (JP) 2008-125663

(51) Int. Cl. B08B 3/12

(52) U.S. Cl. 134/1

(57) ABSTRACT

The present invention is a method of descaling a steel material which removes scale formed at the time of hot rolling a steel material by spraying jets of high pressure water from a plurality of nozzles on to the surface of the steel material, the method of descaling a steel material comprising giving pulsation of a frequency of 3.0 kHz to 200 kHz by direct vibration by a vibrator or vibration due to resonance to the high pressure water and setting a distance from each nozzle to the steel slab at 50 to 700 mm in range. Due to this, there is provided a method of producing a hot rolled steel material of a sufficiently good quality removing scale from a difficult-to-descale steel slab such as high Si steel without requiring high pressure water of an extremely high discharge pressure and while easing temperature restrictions on the heating furnace.

### TECHNICAL FIELD

The present invention relates to a method of removing scale formed on the surface of a steel slab in the process of treatment of a steel material by spraying jets of high pressure water. In particular, it is effective for the difficult-to-descale high Si steel.

### BACKGROUND ART

In general, in hot rolling, a heating furnace is used to heat a steel slab, then the slab is rolled by rough rolling and final rolling to produce a hot rolled steel material. At the time of high temperature heating at the heating furnace, primary scale is formed on the surface of the steel slab and secondary scale is formed from the start of rough rolling to the final rolling process, but if the steel is rolled without these scale being removed, the scale cuts into the product surface and results in scale defects. To prevent the formation of such scale defects, jets of high pressure water are sprayed at the steel slab surface for descaling right before the rough rolling mill and final rolling mill so as to remove the primary scale and secondary scale.

On the other hand, if the descaling causes the steel slab to overly drop in temperature, uniform hot rolling becomes no longer possible and shape defects result, so in the descaling process, it is considered necessary to sufficiently remove the scale while suppressing a drop in temperature.

In recent years, in high strength steel sheet used for automobiles etc., Si is added to improve the formability and raise the strength, but the scale formed on the surface of a steel material containing Si is difficult to completely remove by descaling. Part of the scale, that is, the FeO (wustite), remains at the steel material surface. In the subsequent rolling process, the FeO comes into contact with the air while being crushed and becomes Fe₂O₃ (hematite) which is then pushed into the steel material surface. In this way, scale-like defects called “Si scale” or “red scale” are formed at the surface of the steel material. This Si scale is removed by pickling, but roughness forms at the surface of the steel sheet after pickling at the parts where scale had remained and parts where it had not remained before the pickling, so these easily form starting points of fatigue breakage, further cause uneven coating when used as a member of some equipment, and detract from the appearance of automobile wheels or other final products.

As explained above, even with a steel material on which scale defects are formed, if cold rolling, it is possible to eliminate such roughness, but at parts where black scale (dense scale made mainly of FeO and Fe₃O₄) is formed and parts where Si scale is formed, there are differences in the chemical composition near the surface of the steel, so alloying proceeds unevenly at the time of hot dip galvanization and uneven plating occurs.

Therefore, to add Si as a method of raising the strength of the steel material, it is necessary to solve these problems. To solve the above problems of Si steel, it is necessary to strengthen the descaling performed before the rough rolling or final rolling of the hot rolling and sufficiently remove scale from the surface.

Patent Document 1 discloses a method of hot rolling high Si steel having an Si content of 0.5 mass % or more comprising heating in the state with the surface of the steel material at less than the temperature at which FeO and Fe₂SiO₄ co-precipitate (1173° C.) and descaling by a prescribed impact flow rate or impact energy of the descaling water. To satisfy these conditions, it describes examples of high Si steel of Si≧1 mass % using high pressure water of a discharge pressure of 45 MPa or more. However, in a method of heating with a steel material surface at less than 1173° C., the descaling ability is improved, but the temperature elevation rate of the slab falls, so there are the problems that the heating time at the heating furnace becomes longer and the throughput falls. Further, since 45 MPa or more high pressure water is used, there is the problem that the facility becomes larger in size and the cost rises and that the prime unit of power of descaling deteriorates.

Patent Document 2 discloses a method of introducing an abrasive powder into the high pressure water so as to improve the descaling capability, but there are the problems of the increase in cost and wear of the facilities due to the addition of the abrasive powder and further of the abrasive powder itself being pushed into the steel slab and becoming a new cause of defects.

Patent Document 3 discloses a system improving the nozzle shape, attaching flow regulating devices in the nozzles, and efficiently spraying jets of high pressure water, but this only reduces the jet energy loss. It does not strengthen the descaling ability and cannot sufficiently remove the scale from the surface.

Patent Document 4 discloses a method of improving the descaling capability using high pressure fluid by causing the pressure of a fluid to pulsate about a predetermined pressure and a system for the same. However, the system disclosed in Patent Document 4 uses a mechanical technique to give pulsation to high pressure water. The durability of the system, including the piping etc., therefore becomes a problem. Further, due to the system structure, the pulsation frequency also cannot be made a high frequency, so there were limits to improvement of the descaling capability.

Patent Document 5, like Patent Document 4, discloses a method of improving the descaling capability by giving pulsation to high pressure water and proposes a specific pulsation frequency or pulsation pressure ratio. However, the method disclosed in Patent Document 5 uses a pulsation pressure ratio of 2 or more, but the frequency of the pulsation is a low 500 to 2000 Hz, so in the same way as Patent Document 4, the improvement of the descaling capability resulting from giving the pulsation is not sufficient and scale formed on the steel slab cannot be sufficiently removed.

### PRIOR ART DOCUMENTS

### Patent Documents

Patent Document 1: Japanese Patent Publication (A) No. 2000-254724

Patent Document 2: Japanese Patent Publication (A) No. 5-57332

Patent Document 3: Japanese Patent Publication (A) No. 6-91320

Patent Document 4: Japanese Patent Publication (A) No. 5-285524

Patent Document 5: Japanese Patent Publication (A) No. 7-51730

### SUMMARY OF THE INVENTION

### Problem to be Solved by the Invention

In hot rolling of high Si steel, by applying the art disclosed in Patent Document 1, the descaling ability is improved, but there are the problems of a rise in costs accompanying the increased size of the facilities and deterioration of the prime unit of power of descaling. Further, even if applying other of the above known art for descaling, it was not possible to completely remove the scale. For this reason, Si scale remained at the product after hot rolling and a sufficient quality of hot rolled steel sheet could not be produced.

The present invention has as its object to solve the above problem and provide a method of producing a good quality hot rolled steel material by removing scale from a difficult-to-descale steel material such as high Si steel while suppressing a drop in temperature of the steel slab surface, without requiring high pressure water of an extremely high discharge pressure, and while easing temperature restrictions on the heating furnace.

### Means for Solving the Problem

To solve the above problem, the inventors engaged in in-depth studies and as a result discovered that by imparting high frequency vibration to high pressure water, the atomization of the jet of high pressure water is further assisted and the impact due to the water hammer effect is increased and further that the higher the pulsation frequency, the higher the descaling capability and thereby completed the present invention.

The gist of the present invention is as follows:

(1) A method of production of hot rolled steel sheet removing scale formed at the time of hot rolling a steel material by spraying jets of high pressure water on to the surface of the steel material, the method of production of hot rolled steel sheet comprising imparting pulsation of a frequency of 3.0 kHz to 200 kHz by direct vibration by a vibrator or a part connected from the vibrator or by vibration due to resonance of the vibrator to the high pressure water and setting a distance from each nozzle to the steel slab at 50 to 700 mm in range.

(2) A method of production of hot rolled steel sheet as set forth in (1), wherein the steel material is a steel material containing Si in an amount of 0.2 mass % or more, a discharge pressure of the high pressure water from each nozzle is made 10 MPa to 60 MPa, and the flow rate per nozzle is 20 to 300 L/min.

(3) A method of production of hot rolled steel sheet as set forth in (1) or (2), wherein a pulsation pressure ratio of the high pressure water is 1.5 or less.

(4) A method of production of hot rolled steel sheet as set forth in any one of (1) to (3) wherein the nozzles are flat spray nozzles.

### EFFECTS. OF THE INVENTION

According to the method of production of hot rolled steel sheet of the present invention, it is possible to greatly increase the descaling capability of difficult-to-descale high Si steel in hot rolling and produce a sufficiently good quality hot rolled steel sheet without causing a rise in capital costs or deterioration of the prime unit of power of the descaling. The industrial significance is tremendous.

### BRIEF DESCRIPTION OF THE DRAWINGS

FIG. 1 is a schematic view showing an example of the state of the a jet of water sprayed from a flat spray nozzle.

FIG. 2 is an example of a high speed photograph of the state of a jet of water sprayed from a flat spray nozzle.

### EMBODIMENTS OF THE INVENTION

Below, preferred embodiments of the present invention will be described in detail. First, the technical idea of the present invention will be explained.

The present invention is a method of production of hot rolled steel sheet improving the descaling capability and enabling hot rolling giving good surface properties when hot rolling high Si steel sheet or other difficult-to-descale steel materials.

In high strength steel sheet, Si is added to increase the strength, but along with an increase in the amount of addition of Si, the descaling ability falls. In particular, for scale formed at the surface of a steel material containing Si in an amount of 0.2 mass % or more, with descaling of a discharge pressure of 10 MPa or so, the descaling ability becomes extremely low. Even if using high pressure water of 50 MPa or so, strict operating restrictions are required on the heating conditions of the steel slab. This is because Fe₂SiO₄, a composite oxide of Fe and Si, forms at the interface of the scale and steel material, the adhesion of the Fe₂SiO₄ and steel material is extremely good, so removal of Fe₂SiO₄ is difficult.

To produce steel sheet excellent in surface properties, it is necessary to spray jets of high pressure water at the entire surface of the steel slab facing the nozzles, so in general in an actual descaling facility, one to three lines of nozzles spraying jets of high pressure water, each line including a plurality of nozzles, are provided.

With descaling in the hot rolling process, due to the combination of the physical impact when the high pressure water strikes the surface of the steel slab and the heat impact due to the low temperature water striking the high temperature scale, the scale on the surface of the steel slab is broken away. For this reason, in the past, as measures for strengthening the descaling, the pressure of the water has been increased and the flow rate has been raised.

A jet of high pressure water sprayed from a nozzle changes from a continuous flow to an atomized flow in accordance with the distance from the nozzle. The jet in the continuous flow region right after emerging from this nozzle has a high average pressure, a small standard error, and other features, so is used for cutting stone, concrete, etc. Further, the distance from the nozzle of 100 to 600 mm or so in range is the atomized flow region. The average pressure is constant over a relatively broad range and the atomized particles strike the steel slab or other target in an impact manner. It is known that when the high speed water particles are atomized and strike the steel slab, the water hammer effect causes the impact to increase resulting in an impact several times the magnitude of the case where a continuous flow strikes a slab. Due to these characteristics, the atomized region of the high pressure water is used for the descaling. To improve the descaling capability without an accompanying increase in pressure of the jets of water or increase in the flow rate, uniformly atomizing the jets of high pressure water is effective.

The inventors discovered that by using a vibrator to give high frequency pulsation to the high pressure water, the sprayed jets of high pressure water are uniformly atomized and that even if the discharge pressure or flow rate of the jets of high pressure water are constant, the higher the pulsation frequency, the higher the descaling capability.

The methods of giving pulsation to high pressure water roughly include two methods: the mechanical type and vibration type.

In the mechanical type, there is the method of opening and closing a channel near the ejection port of the high pressure water and the method such as in Patent Document 4 of using a piston etc. to change the volume of a pipe or chamber in a nozzle so as to give pulsation.

However, from the relationship of the standard line speed of 50 to 500 m/min of the steel material in the hot rolling process and the thickness of about 10 mm of the descaling water, pulsation of several hundred Hz or more is necessary. With the method of giving pulsation of a high frequency to the high pressure water by a mechanical operation, there is a problem in the durability of the operating parts. Application to descaling of a hot rolling process in which stable long term operation is sought is difficult.

On the other hand, with the method of using a vibrator to give pulsation to high pressure water, there are no mechanical operating parts, so the durability is high and application to descaling becomes possible. Further, since high frequency pulsation can be given more easily than by the mechanical type, atomization of the high pressure water is promoted and the descaling capability is improved.

In particular, if the frequency of the pulsation becomes 3.0 kHz or more, atomization is uniformly promoted. Further, by giving the energy of high frequency vibration to the jet energy of high pressure water, the descaling capability is further improved. Note that, in the present invention, when giving pulsation to high pressure water, the vibrator need not directly contact the high pressure water. For example, a part connected from the vibrator such as a waveguide rod may guide the vibration to the high pressure water. The methods of using a vibrator to give pulsation to high pressure water for example include the method described in Japanese Patent Publication (B2) No. 2007-523751 and the method described in Japanese Patent Publication (A) No. 7-178700.

When using the impact when a jet of water strikes a steel slab so as to break and remove scale, it is known that raising the flow density of the jet of water is effective. For example, when using a flat spray nozzle, by making the thickness of the jet of water sprayed in a fan shape thinner to raise the flow density, the descaling ability is improved. In the present invention, by giving pulsation, uniform atomization of the jet of water is promoted. Further, it may be that by giving high frequency vibration energy to the sprayed jet of water and having the large flow density jet of water impact the surface, the descaling ability is strikingly improved.

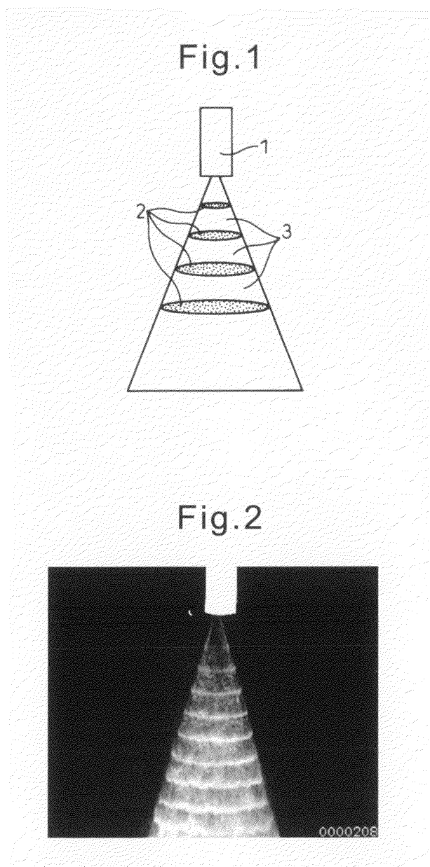

The inventors photographed a jet of water sprayed while changing the discharge pressure (three patterns of shooting frames every 1 μsec, 2 μsec, and 4 μsec) by a high speed video camera and analyzed the images so as to find the pulsation frequency and flow rate of the sprayed jet of water. FIG. 1 is a schematic view of an example of the state of the jet of water when using a flat spray nozzle to fire high pressure water in a fan shape, while FIG. 2 shows an example of a high speed photograph (4 μsec/frame). From the high speed photograph of FIG. 2, different densities of the jet can be observed according to the flow density. As shown by the schematic view of FIG. 1, it could be confirmed that with the sprayed jet of water according to the present invention, a large flow density region 2 and small flow density region 3 are alternately formed right after being sprayed from the flat spray nozzle 1 and pulsation occurred in the density of the flow rate. This was confirmed by analysis to be the same frequency as the frequency imparted by the vibrator.

Next, the inventors investigated the pulsation of the discharge pressure. It is known that the following relationship stands between the discharge pressure and flow rate of the sprayed jet of water due to Bernoulli's theorem. That is, the larger the discharge pressure, the larger the flow rate of the jet of high pressure water.

v∞(2P/ρ)^{0.5} (1)

where, v: flow rate of the jet of water, P: discharge pressure, and p: density of water.

Directly measuring the high speed fluctuation of the discharge pressure itself is difficult, so the inventors decided to measure it from formula (1) using the flow rate. However, the jet of water sprayed from a nozzle is decelerated due to the air resistance along with the increase in the flight distance from the nozzle. This effect becomes more remarkable the smaller the flow density of the region. Therefore, when calculating the discharge pressure, it is necessary to use the discharge flow rate (value of flow rate near nozzle), but if the distance from the nozzle is too short, the measurement error of the flight distance and time becomes relatively large and the error of the value of the flow rate becomes larger. Therefore, in the present invention, the inventors analyzed the maximum region and minimum region of the flow rate in the sprayed jet of water in the region up to 50 mm from the nozzle tip, found the maximum value and the minimum value of the flow rate, and found the maximum value and the minimum value of the discharge pressure by formula (1) from these maximum value and the minimum value of the flow rate in the pulsating jet of water. That is, the “pulsation pressure ratio” referred to in the present invention is defined as the ratio of the maximum value and minimum value of the discharge pressure of the high pressure water up to 50 mm from the nozzle tip. If measuring the actual pulsation pressure ratio, as shown in Table 2, the pulsation pressure ratio of the high pressure water according to the present invention was at a maximum 1.5.

As explained above, the jet of water sprayed from a nozzle is decelerated by the air resistance. This becomes remarkable in the small flow density region, so even at 50 mm from the nozzle tip, when the flow rate is small, the error becomes further larger. Therefore, the pulsation pressure ratio defined by present invention is found from the flow rate ratio at 50 mm from the nozzle, but it can be deduced that the flow rate ratio right after the discharge port is smaller than that. That is, the pulsation pressure ratio right after the discharge port is smaller than 1.5. If checked considering error etc., it is probably 1.0 to 1.1 or so.

That is, the spray jet of the high pressure water given high frequency vibration according to the present invention is believed to have a small pulsation of the pressure or flow rate and a large pulsation of the flow density.

In the present invention, the reason why the fluctuations in the discharge pressure are small and the flow density of a sprayed jet of water greatly pulsates is not clear at the present point of time, but due to the resonance phenomenon of high frequency vibration, it is believed that the flow rate when the high pressure water is sprayed from the nozzle greatly pulsates.

Next, the mechanism of improvement of the descaling ability of high pressure water given high frequency vibration according to the present invention will be considered.

When using the impact when a jet of water strikes a steel slab so as to break and remove scale, it is known that raising the flow density of the jet of water is effective. Therefore, when using a flat spray nozzle, by making the thickness of the jet of water sprayed in a fan shape thinner to raise the flow density, the descaling ability is improved. The mechanism by which an increase in the flow density improves the descaling ability is not clear, but it is guessed that by raising the flow density, the size of the water particles becomes larger and thereby the impact pressure at the time of striking the steel slab becomes larger and the descaling ability is improved.

That is, in the present invention, giving pulsation results in uniform atomization being promoted. Due to the large flow density, a jet of water of large sized particles is periodically formed. Due to this, the descaling ability is strikingly improved.

Furthermore, these water particles are given high frequency vibration energy, so are believed to have some sort of effect on the water hammer phenomenon when the water particles strike resulting in an increase in the impact pressure and a further improvement in the descaling ability.

The descaling method disclosed in Patent Document 5 features a low frequency of vibration imparted, but a high pulsation pressure ratio of 2 or more, so the flow rate of the sprayed jet of water greatly fluctuates. A descaling effect is obtained by the action of this fluctuation in pressure. On the other hand, the high pressure water according to the present invention gives a 3 kHz or more high frequency vibration, so the pulsation pressure ratio of the discharge pressure is small, but on the other hand, the flow density of the sprayed jet of water greatly pulsates. Due to this high flow density, the descaling effect is strikingly improved. The mechanism greatly differs from the prior art of Patent Document 5 etc.

Below, reasons for limitation of the conditions in the present invention will be explained.

The vibration number of the pulsation of the high pressure water was made 3.0 kHz or more because with a pulsation of less than 3.0 kHz, the atomization of the high pressure water is not sufficient. Further, the energy of the high frequency vibration is also small, so the effect of pulsation cannot be sufficiently obtained. Further, the vibration number of the pulsation of the high pressure water was made 200 kHz or less because giving pulsation of a frequency over 200 kHz to high pressure water of a pressure and flow rate required for descaling is difficult with the current level of technology. From the viewpoint of the improvement of the descaling capability and the improvement of the durability of the vibrator, the vibration number of the pulsation of the high pressure water is more preferably 10 kHz to 50 kHz in range. If possible, if pulsation in the so-called ultrasonic region of 20 kHz or more, a greater descaling effect is obtained.

The length of the vertical line when dropping a vertical line from a nozzle to the steel slab, that is, the distance from the nozzle to the steel slab, was made 50 mm or more because if a distance of less than 50 mm, even if giving pulsation, the atomization of the high pressure water is not sufficient and the effect cannot be obtained. Further, the distance from the nozzles to the steel slab was made 700 mm or less because if a distance over 700 mm, the effect of the pulsation falls and sufficient descaling is no longer possible. To sufficiently bring out the effect of atomization and pulsation, the distance from the nozzles to the steel slab is more preferably made 70 to 400 mm.

Fe₂SiO₄ difficult to remove by descaling forms at the interface of the scale and steel material, so along with an increase in the amount of addition of Si, the descaling ability falls. In particular, if the content of the Si in the steel material becomes larger than 0.2 mass %, the descaling ability sharply drops.

With descaling with a discharge pressure of about 10 MPa, the descaling ability becomes extremely low. Even when using high pressure water of about 50 MPa, strict restrictions on operation have to be imposed on the heating conditions of the steel slab. This is because Fe₂SiO₄, a composite oxide of Fe and Si, forms at the interface between the scale and steel material. The adhesion between the Fe₂SiO₄ and the steel material is extremely good, so removal of the Fe₂SiO₄ is difficult.

Further, the discharge pressure from the nozzles was made 10 MPa or more because if the discharge pressure is less than 10 MPa, the pressure becomes too small, so even if giving pulsation, sufficient descaling may not be possible. Further, the discharge pressure was made 60 MPa or less because spraying over 60 MPa high pressure water would have the problem of the facility becoming larger in size and the cost rising. From the viewpoint of the capital costs, the discharge pressure is more preferably 10 MPa to 30 MPa in range.

The sprayed flow rate per nozzle was made 20 to 300 L/min because with a flow rate of less than 20 L/min, the heat impact is small, so even if giving pulsation, sufficient descaling may not be possible. On the other hand, giving pulsation to high pressure water of a flow rate of over 300 L/min is difficult with the current level of technology. Further, the temperature of the steel material surface falls and uniform rolling becomes difficult. To achieve both stable descaling and rolling over a long term, the sprayed flow rate is more preferably made 50 to 200 L/min in range.

The pulsation pressure ratio of the high pressure water was made 1.5 or less because the pulsation pressure ratio calculated from the actually measured value of the flow rate of the sprayed jet of water according to the present invention is at most 1.5, so this was made the upper limit. The larger the pulsation pressure ratio, the larger the stress applied to the path of the high pressure water including the nozzles, so from the viewpoint of the durability against fatigue, the smaller the pulsation pressure ratio (the closer to 1), the better.

Below, examples of the present invention will be explained, but the conditions of the examples are examples of conditions employed to confirm the workability and advantageous effects of the present invention. The present invention is not limited to these conditions. The present invention can employ various conditions so long as not departing from the gist of the present invention and achieving the object of the present invention.

### Example 1

Si steel materials of the compositions of ingredients containing Si in 0.15 and 0.35 mass % shown in Table 1 and sizes of 300×300×30 mm were used. Each steel material was heated by a heating furnace at 1200° C. for 120 min, then the steel material was extracted from the heating furnace, then high pressure water was sprayed on the surface of the steel material from a single nozzle. At each of the descaling conditions, a nozzle giving a spray width at the surface of the steel material of about 100 mm was used. Vibrators having an inherent vibration number of 2 kHz, 3 kHz, and 20 kHz were used. The discharge pressure from the nozzle was 20 MPa. High pressure water of a rate of 50 L/min per nozzle was sprayed. For the nozzle, a flat spray nozzle was used.

TABLE 1
Composition of Steel Slab

Main ingredient composition (mass %),
balance: substantially Fe

| Sample | C | Si | Mn | Cr |
|---|---|---|---|---|
| A | 0.12 | 0.15 | 0.5 | 0.02 |
| B | 0.08 | 0.35 | 1.25 | 0.02 |

Note that the scale peelability was evaluated by using an optical microscope to observe the surface of the steel material after descaling, finding the area rate of the remaining scale, defining this as the residual scale rate, and defining a residual scale rate of 20% or less as good and a residual scale rate of over 20% as poor.

As shown in Table 2, when the distance from the nozzles to the steel slab is 50 to 700 mm in range, by making the descaling water pulsate by a vibrator according to the method of the present invention, it was confirmed that the atomization of the high pressure water was promoted and the descaling capability was strengthened.

TABLE 2
Descaling Conditions and Residual
Scale Rate

| | | | Nozzle- | | | |
|---|---|---|---|---|---|---|
| | | Pulsation | steel slab | Residual | Pulsation | |
| | Sam- | frequency | distance | scale rate | pressure | |
| No. | ple | (KHz) | (mm) | (area %) | ratio | Class |
| 1 | A | 20 | 200 | <5 (good) | 1.1 to 1.2 | Invention |
| 2 | A | 3 | 200 | <5 (good) | 1.5 | Invention |
| 3 | A | 20 | 50 | 10 (good) | 1.1 to 1.2 | Invention |
| 4 | A | 20 | 700 | 10 (good) | 1.1 | Invention |
| 5 | A | 2 | 200 | 40 (poor) | 2.5 | Comp. ex. |
| 6 | A | No | 200 | 50 (poor) | — | Comp. ex. |
| | | pulsation | | | | |
| 7 | A | 20 | 30 | 40 (poor) | 1.1 to 1.2 | Comp. ex. |
| 8 | A | 20 | 900 | 40 (poor) | 1.1 | Comp. ex. |
| 9 | B | 20 | 200 | <5 (good) | 1.3 | Invention |
| 10 | B | 3 | 200 | 20 (good) | 1.4 | Invention |
| 11 | B | 2 | 200 | 50 (poor) | 2.2 | Comp. ex. |
| 12 | B | No | 200 | 70 (poor) | — | Comp. ex. |
| | | pulsation | | | | |
| 13 | A | 200 | 200 | <5 (good) | 1.1 | Invention |

### Example 2

Si steel materials of the compositions of ingredients containing Si in 0.35 and 1.0 mass % shown in Table 3 and sizes of 300×300×30 mm were used. Each steel material was heated by a heating furnace at 1200° C. for 120 min, then the steel material was extracted from the heating furnace, then high pressure water was sprayed from a single nozzle on to the surface of the steel material. At each of the descaling conditions, a nozzle giving a spray width at the surface of the steel material of about 100 mm was used. Vibrators having an inherent vibration number of 5 kHz, 20 kHz, and 100 kHz were used

TABLE 3
Composition of Steel Slab

Main ingredient composition (mass %),
balance: substantially Fe

| Sample | C | Si | Mn | Cr |
|---|---|---|---|---|
| B | 0.08 | 0.35 | 1.25 | 0.02 |
| C | 0.06 | 1.0 | 1.2 | 0.1 |

Note that the scale peelability was evaluated by using an optical microscope to observe the surface of the steel material after descaling, finding the area rate of the remaining scale, defining this as the residual scale rate, and defining a residual scale rate of 20% or less as good and a residual scale rate of over 20% as poor.

As shown in Table 4, it was confirmed that by making the descaling water pulsate by a vibrator according to the method of the present invention, the descaling capability is strengthened and the scale formed on high Si steel can be sufficiently removed. Further, it was confirmed that by making the discharge pressure from each nozzle 10 MPa to 60 MPa and making the flow rate per nozzle 20 to 300 L/min in range, the residual scale rate became an extremely good value (<5%).

TABLE 4
Descaling Conditions and Residual
Scale Rate

| | | | | | Nozzle- | Residual | | |
|---|---|---|---|---|---|---|---|---|
| | | Pulsation | Discharge | | steel slab | scale | Pulsation | |
| | | frequency | pressure | Water flow | distance | rate | pressure | |
| No. | Sample | (kHz) | (MPa) | (L/min) | (mm) | (area %) | ratio | Class |
| 21 | B | 20 | 10 | 100 | 200 | <5 (good) | 1.1 to 1.2 | Invention |
| 22 | B | 5 | 10 | 20 | 50 | <5 (good) | 1.5 | Invention |
| 23 | B | 20 | 5 | 100 | 200 | 10 (good) | 1.3 | Invention |
| 24 | B | 20 | 20 | 20 | 200 | 20 (good) | 1.1 to 1.2 | Invention |
| 25 | B | No | 50 | 200 | 200 | 30 (poor) | — | Comp. ex. |
| | | pulsation | | | | | | |
| 26 | C | 20 | 50 | 100 | 200 | <5 (good) | 1.1 to 1.2 | Comp. ex. |
| 27 | C | 20 | 10 | 100 | 200 | <5 (good) | 1.2 | Invention |
| 28 | C | 5 | 10 | 20 | 50 | <5 (good) | 1.4 | Invention |
| 29 | C | 20 | 10 | 100 | 200 | 20 (good) | 1.3 | Invention |
| 30 | C | 20 | 20 | 20 | 200 | 20 (good) | 1.2 | Invention |
| 31 | C | 100 | 10 | 100 | 200 | 10 (good) | 1.1 | Invention |
| 32 | C | 100 | 20 | 20 | 200 | 10 (good) | 1.1 | Invention |
| 33 | C | No | 50 | 200 | 200 | 70 (poor) | — | Comp. ex. |
| | | pulsation | | | | | | |
| 34 | C | 20 | 60 | 100 | 200 | <5 (good) | 1.1 | Invention |
| 35 | C | 20 | 20 | 300 | 200 | <5 (good) | 1.1 | Invention |
| 36 | C | 20 | 20 | 10 | 200 | 30 (poor) | 1.1 | Comp. ex. |
| 37 | C | 20 | 5 | 100 | 200 | 30 (poor) | 1.3 | Comp. ex. |
| 38 | C | 20 | 20 | 100 | 700 | 10 (good) | 1.3 | Invention |

Above, preferred examples of the present invention were explained, but the present invention is not limited to these examples needless to say. It is clear that a person skilled in the art could easily conceive of various modifications or revisions within the scope described in the Claims and Description. These should also naturally be understood as falling under the technical scope of the present invention. Further, the present invention deals mainly with application to descaling of hot rolled steel sheet, but needless to say it is not limited to only hot rolled steel sheet and may also be applied to descaling of surface scale of, for example, seam welded pipe and other iron pipe products.

### INDUSTRIAL APPLICABILITY

According to a method of production of hot rolled steel sheet according to the present invention, it becomes possible to greatly strengthen the descaling capability of difficult-to-descale high Si steel in hot rolling and produce good quality hot rolled steel sheet with a good productivity and low cost without causing a rise in capital costs and prime cost of power of descaling. We are convinced this will greatly contribute to users of steel materials such as the automobile industry or other industrial fields.

### EXPLANATION OF NOTATIONS

1 flat spray nozzle
2 region of large flow density
3 region of small flow density

1. A method of production of hot rolled steel sheet removing scale formed at the time of hot rolling a steel material by spraying jets of high pressure water on to the surface of the steel material, the method of production of hot rolled steel sheet comprising imparting pulsation of a frequency of 3.0 kHz to 200 kHz by direct vibration by a vibrator or a part connected from the vibrator or by vibration due to resonance of the vibrator to the high pressure water and setting a distance from each nozzle to the steel slab at 50 to 700 mm in range.

2. A method of production of hot rolled steel sheet as set forth in claim 1, wherein said steel material is a steel material containing Si in an amount of 0.2 mass % or more, a discharge pressure of said high pressure water from each said nozzle is made 10 MPa to 60 MPa, and said flow rate per nozzle is 20 to 300 L/min.

3. A method of production of hot rolled steel sheet as set forth in claim 1 or 2, wherein a pulsation pressure ratio of said high pressure water is 1.5 or less.

4. A method of production of hot rolled steel sheet as set forth in claim 1 or 2 wherein said nozzles are flat spray nozzles.
